(19) United States
(12) Patent Application Publication
(10) Pub. No.: US 2008/0029662 A1
(43) Pub. Date: Feb. 7, 2008

(54) Tool holder attachment for rigid pipe tristand

(76) Inventor: John F. O'Rourke, Sutton, MA (US)

Correspondence Address: NATIONAL IP RIGHTS CENTER, LLC;SCOTT J. FIELDS, ESQ., 550 TOWNSHIP LINE ROAD, SUITE 400, BLUE BELL, PA, 19422, US

(21) Appl. No.: 11/498,553

(22) Filed: Aug. 3, 2006

(51) Int. Cl. F16M 11/02

(52) U.S. Cl. 248/177.1

(57) ABSTRACT

A device for supporting tools on a tristand is disclosed. The device consists of an elongate beam and two tool holding attachments affixed to opposite ends of the beam. The device may be placed on top of the base of a tristand in order to allow the user to conveniently store various kinds of tools.

### FIELD OF THE INVENTION

The present invention is broadly directed towards the fields of carpentry, welding, plumbing, construction, manufacturing, automobile repair, and any other field where heavy duty tools are used. Specifically, the present invention is a device that bolts onto or attaches to a pipe tristand to hold different types of hand tools, such as grinders and pipe wrenches.

### BACKGROUND OF THE INVENTION

Pipe tristands are frequently used in many professions including plumbing, construction, and various forms of mechanical contracting. Tristands generally consist of a base with three extending legs and a chain vise for holding various lengths of pipe or other objects. The legs are often collapsible to assist in transportation. In practice, tristands are typically used to hold a length of pipe on the base by using the chain vise. The pipe is then stably mounted for welding and cutting prior to installation. Due to the fact that tristands essentially operate as a kind of portable workbench, several tristands are built with integrated slots for holding tools. These slots are often located on the base of the tristand. However, these tool holders are often inadequate for storing the amount and type of tools required by the user. Therefore, there is a need for a device which allows the user to store additional tools and is attachable to a tristand.

### SUMMARY OF THE INVENTION

Therefore, it is an object of the present invention to provide an attachment for a tristand that increases the number of tools that can be stored on the tristand.

It is a further object of the present invention to provide an attachment that allows different types of tools, such as grinders, to be stored on a tristand.

In accordance with the foregoing objects, a tool holder attachment for a tristand is set forth. The device consists of an elongate central beam which is to be placed on the base of a tristand and two tool holding attachments on opposite ends of the beam. Because the base of a tristand is triangular, the beam is in the shape of an elongate trapezoid so that the tool holding attachments are flush to the sides of the base. Each tool holding attachments is rectangular in shape and has a large aperture for hanging tools. This allows heavy tools, such as grinders, to be hung on the attachments. One of the tool holding attachments has multiple curved and upwardly extending hooks to allow hammers, wrenches, or other tools to be held. The same attachment additionally has an extension with a circular aperture and upwardly protruding stoppers to allow for additional types of tools to be held.

### BRIEF DESCRIPTION OF THE FIGURES

FIG. 1 is a top plan view of the tool holder attachment.

FIG. 2 is a side perspective view of the tool holder attachment in use on the base of a tristand.

FIG. 3 is a front perspective view of the tool holder attachment in use on the base of a tristand.

### DETAILED DESCRIPTION OF THE INVENTION

The present invention involves an attachment which is placed on top of the base of a tristand. The invention allows the user of a tristand to increase the number and type of tools that may be stored on the tristand.

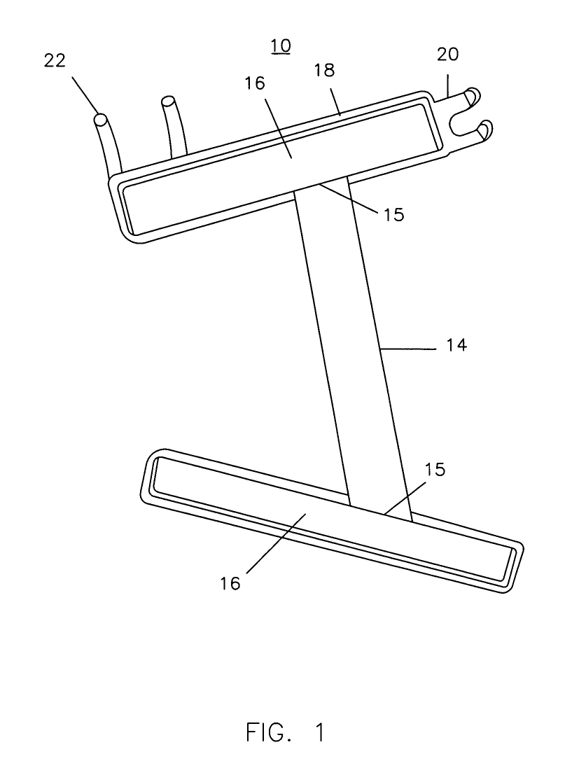

Referring to FIG. 1, a tool holding device 10 for a tristand is set forth. The tool holding device 10 may be constructed using a variety of materials including steel, titanium, aluminum or high tensile strength plastic. The tool holding device 10 consists of an elongate central beam 14 for placement on the base 12 of a tristand and two tool holding attachments 18 affixed to opposite ends of the beam 14. In a preferred embodiment, the beam 14 is in the shape of an elongate trapezoid in order to adapt to the triangular shape of the base of a tristand.

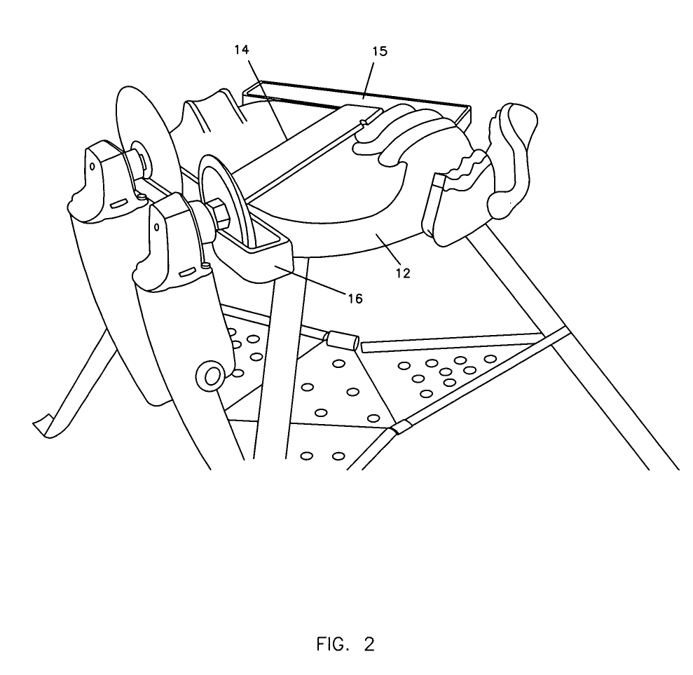

Each attachment 18 has a large aperture 16 in its center for hanging tools such as grinders. Referring to FIG. 2, the circular blade of a grinder may be inserted into an aperture 16 so that it may be hung securely from the attachment 18. In a preferred embodiment, the attachment 18 is in the shape of a rectangle with rounded corners. One of the attachments 18 has multiple upwardly curved hooks 22 affixed thereto in order to hold tools such as wrenches or drills. The same attachment 18 additionally has an extension 20 consisting of a circular aperture and two upwardly extending stoppers. The extension 20 is suitable for holding any tool with a large handle. In practice, the handle will hang through the circular aperture of the extension 20 and the extension's upwardly protruding stoppers will prevent the tool from falling to the ground.

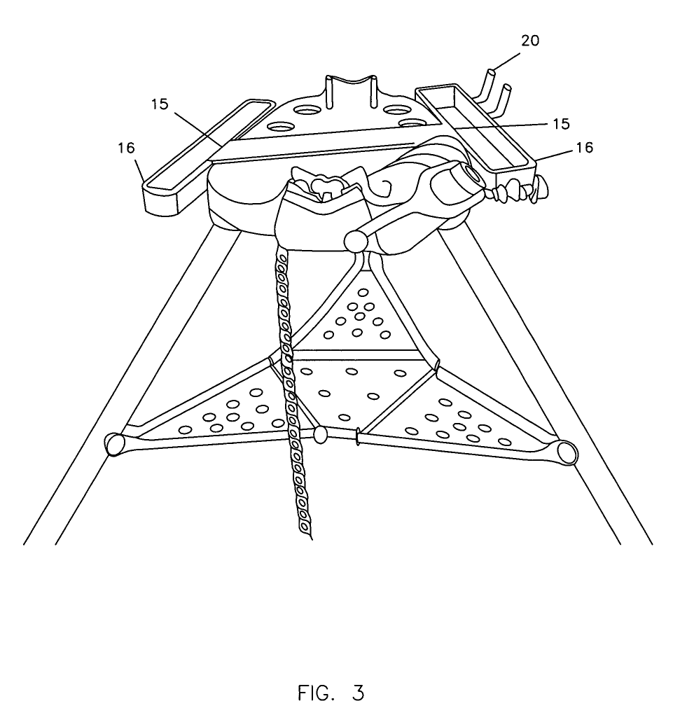

Referring to FIGS. 2 and 3, the tool holder attachment 10 is shown in its operable position on the base 12 of a tristand. The tool holding device 10 fits snugly to the base 12 of the tristand due to the trapezoidal shape of the beam 14 which causes the tool holding attachments 18 to be flush to the sides of the base 12. The device 10 may be affixed to the base by any means known in the art, such as a series of screws or an adhesive.

The present invention has been described with reference to the above discussed preferred embodiment. The true nature and scope of the present invention is to be determined with reference to the claims appended hereto.

I claim:

1. A device for supporting tools on a tristand comprising:
an elongate beam; and
two tool holding attachments affixed to opposite ends of the beam.

2. The device of claim 1 wherein the beam is in the shape of an elongate trapezoid.

3. The device of claim 2 wherein the tool holding attachments are in the shape of a rectangle with rounded corners and are hollow in the center.

4. The device of claim 1 wherein a plurality of curved, upwardly extending hooks are mounted to the outside of a tool holding attachment.

5. The device of claim 4 wherein a tool holding extension with a circular aperture and two upwardly extending stoppers is affixed to the edge of one of said tool holding attachments.

6. A device for supporting tools on a tristand comprising:
an elongate trapezoidal beam;
two tool holding attachments affixed to the opposite ends of said beam, each attachment being in the shape of a rectangle with rounded corners and having a large aperture in the center for hanging tools;
a plurality of curved, upwardly extending hooks mounted to the outside of one of said tool holding attachments; and
an extension consisting of a circular aperture and two upwardly extending stoppers, said extension being affixed to one of said tool holding attachments.
